(19) United States
(12) Patent Application Publication
(10) Pub. No.: US 2004/0103028 A1
(43) Pub. Date: May 27, 2004

(54) Method and system of advertising

(75) Inventors: Earl Littman, Houston, TX (US); John E. McGinnis, Carrollton, TX (US); Rodney C. Montrose, Coppell, TX (US)

Correspondence Address: CONLEY ROSE, P.C., P. O. BOX 3267, HOUSTON, TX, 77253-3267, US

(73) Assignee: The Advertizing Firm, Inc., Houston, TX

(21) Appl. No.: 10/616,000

(22) Filed: Jul. 9, 2003

Related U.S. Application Data
(60) Provisional application No. 60/429,225, filed on Nov. 26, 2002.

(51) Int. Cl. G06F 17/60

(52) U.S. Cl. 705/14

(57) ABSTRACT

A method and related system for advertising that senses the presence of a consumer proximate to a display of goods, invokes (based on the presence of the consumer), an advertisement selected from a group of previously supplied advertisements, and reporting statistics of the invocation of advertisements.

### CROSS-REFERENCE TO RELATED APPLICATIONS

This application claims benefit of United States provisional application serial No. 60/429,225 filed Nov. 26, 2002, which application is incorporated herein by reference as if reproduced in full below.

### STATEMENT REGARDING FEDERALLY SPONSORED RESEARCH OR DEVELOPMENT

Not applicable.

### BACKGROUND OF THE INVENTION

1. Field of the Invention

The preferred embodiments of the present invention are directed to a method and system of advertising. More particularly, various embodiments of the invention may be directed to displaying previously and dynamically supplied advertisements triggered by a detected presence of a consumer, and reporting statistics of the advertising play.

2. Background of the Invention

Advertising has become pervasive in today's society. Traditional advertising methods include television, radio, and publications, while more recent methods include internet-based advertisements. Regardless of the method employed, businesses utilize advertising to introduce consumers to their products and to encourage consumers to purchase their products.

Because a consumer might not purchase the product for days or even months after hearing or seeing an advertisement, most advertising methods, such as television, rely on innovative and creative advertisements that consumers will remember when making the purchase. Other methods for encouraging consumers to purchase a certain product include product demonstrations (e.g., prerecorded advertisements and in-person demonstrations) located close to the actual point of purchase. For example, short product demonstrations and advertisements are sometimes prerecorded on a video and then played in a location proximate to where the products are sold. While prerecorded video and in-person product demonstrations may escalate product sales, they have certain drawbacks, e.g. labor costs associated with in-person demonstrations. Although labor costs may be avoided by using a prerecorded video, the video may require manual and periodic intervention. Accordingly, there is a need for a method of advertising at the point of sale that may overcome the disadvantages of existing advertising methods.

### BRIEF SUMMARY OF SOME OF THE PREFERRED EMBODIMENTS

The problems noted above are solved in large part by a method and related system for displaying advertisements. One aspect of the embodiments of the invention may be a method comprising: sensing presence of a consumer proximate to a display of consumer goods, invoking (based on the presence of the consumer) an advertisement directed to at least one sense of the consumer, and reporting statistics of invocation of advertisements. Detecting presence of the consumer may comprise ultrasonically detecting the consumer or movement of inanimate objects caused by the consumer, detecting electric and/or electromagnetic field changes associated with the presence of the consumer, optically detecting the presence of the consumer, and/or detecting a radio frequency identification device carried by the consumer. The advertisement directed to the sense of the consumer may comprise an audio clip, a video clip, an audio/visual presentation, or possibly releasing of a chemical to appeal to the consumer's sense of smell.

A second aspect of the embodiments of the invention may be an advertising system comprising: a first computer system, and a remote advertising player coupled to the first computer system by way of a communication system. The remote advertising player may sense the presence of a person, play advertisements stored in the remote advertising player supplied by the first computer system, and report a notice of advertising play to the first computer system. The remote advertising player may further comprise a communication device for reproducing an audio and/or video clip. The communication device may comprise devices such as a video display and/or an audio speaker.

Yet another aspect of the embodiments of the invention may comprise a system having: a processor, a random access memory (RAM) coupled to the processor, a communication device coupled to the processor, a sensing device coupled to the processor, and an advertisement reproduction device coupled to the processor. The system may receive advertisements by way of a radio frequency communication and store the advertisements, possibly in the RAM. The processor may be programmed to sense proximity of a consumer using the sensing device, and when the consumer is detected, the processor may play an advertisement stored in the RAM on the advertisement reproduction device. The processor may further report statistics of advertising play to external devices across the communication device. The advertisement reproduction device may comprise devices such as a video monitor and/or a video monitor having a touch-screen control panel.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates an advertising system constructed in accordance with at least some embodiments of the invention;

FIG. 2 illustrates a store controller constructed in accordance with at least some embodiments of the invention; and

FIG. 3 illustrates an advertising player constructed in accordance with at least some embodiments of the invention.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

At least some of the embodiments of the invention were developed in the context of displaying advertisements within the freezer section of a grocery store, possibly triggered by opening of a door on a freezer compartment. The following specification is, therefore, related to the developmental context; however, describing the various embodiments of the invention in relation to the developmental context should not be construed as a limitation as to the breadth and applicability of the invention. The methods and systems described herein may find applicability in other advertising situations.

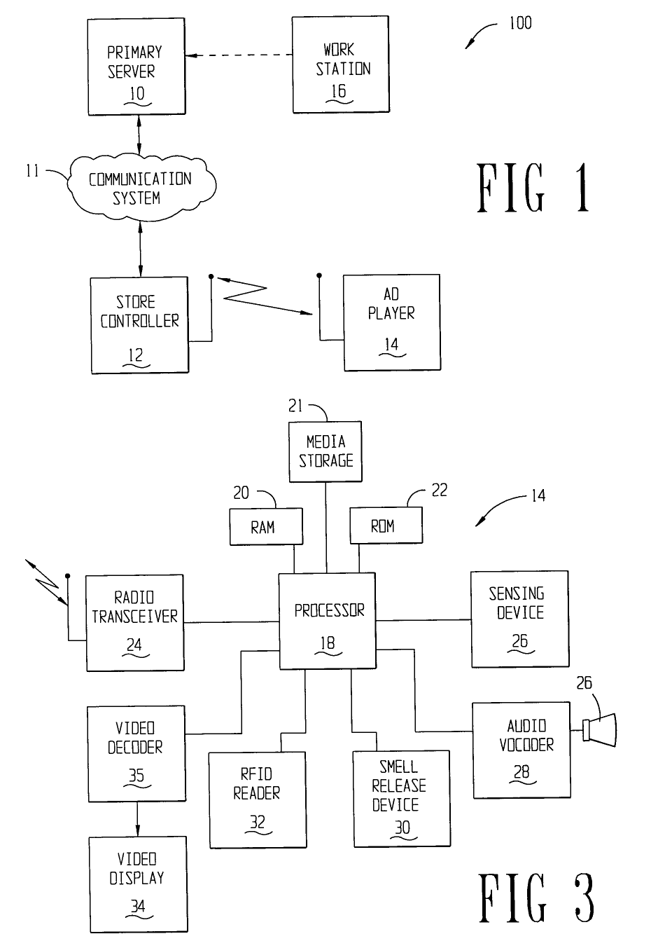

FIG. 1 illustrates an advertising system 100 constructed in accordance with at least some embodiments of the invention. The advertising system may comprise a primary server 10. The primary server may be a single computer system, or an array of computer systems coupled together to form a network. The primary server or servers 10 may be any available computer system, such as may be available from vendors like Hewlett-Packard and Dell. The primary server 10 may be a Windows® or Unix® based system. The primary server 10 may couple to a store controller 12 by way of a communication system 11. The communication system 11 may comprise any suitable communication system, such as the Internet, dedicated telephone line connections, across power lines, and satellite communications. The store controller 12 may likewise be a computer system, though in some embodiments the store controller 12 may not require the degree of computing capability that may be present in primary server 10.

In at least some embodiments of the invention the store controller may be located remote from the primary server 10, possibly in a retail store of any variety. In the exemplary case of utilizing the embodiments of the invention in a grocery store, the store controller 12 may be placed at an inconspicuous location within the grocery store. The store controller 12 communicate, possibly wirelessly, with one or more advertising players 14 within the general vicinity of the store controller 12. In the exemplary case of a grocery store, a single store controller 12 may be in communication with a plurality of advertising players 14 at various locations throughout the store.

Still referring to FIG. 1, the advertising system 100 may also comprise a work station 16 coupled to the primary server 10. The work station 16 may be used to generate advertisements in various audio and video formats. Once created, the advertisements may be stored in the primary server 10: The work station 16 may be any available computer system, using any suitable operating system, capable of creating and/or editing audio and video content. In alternative embodiments, the work station 16 may not be present, with advertisements being supplied from other sources.

While the exemplary system illustrated in FIG. 1 shows only one store controller coupled to the primary server, the primary server 10 may communicate with a plurality of store controllers, with one or more store controllers possibly placed in each retail store. Likewise, though FIG. 1 shows only one advertising player 14 wirelessly coupled to store controller 12, each designated area controlled by a store controller may comprise a plurality of advertising players 14.

In accordance with embodiments of the invention, server 10 may maintain a repository of advertisements. Each advertisement may be assigned a unique identifier. For example, the identifier may be a 4-byte identifier, thus allowing approximately 2.5 billion unique identifiers. Using server 10, advertisements may be converted from their source format (e.g., JPEG, .WAV, .MP3, etc.) to a desired file format, and stored into files in a database within the server 10.

Server 10 may also manage advertiser records including organizing current and future advertisements. Managing advertiser records may include maintaining a database of stores and remote playing devices in those stores, and tracking the status of advertising players 14.

Server 10 may also be responsible for downloading advertisements to the advertising players 14, and maintaining a database of advertisements residing at the advertising players 14. In one embodiment, an advertising player 14 may have multiple media slots to which the server 10 sends the advertisement. A media slot may be a portion of memory within the advertising player within which an advertisement may be stored. The advertising player 14 may, for example, play the advertisements contained in a plurality of media slots sequentially, or the advertising player 14 may randomly select from the various advertisements stored in the media slots. Advertisements may be downloaded to a single advertising player 14 or a group of advertising players 14. The server 10 may query advertising players 14 to determine statistics or a metric of advertising play. If an advertising player 14 acknowledges that a particular advertisement was successfully played, then the server 10 may signal the advertising player 14 to delete the record from its storage, and transfer a new advertisement.

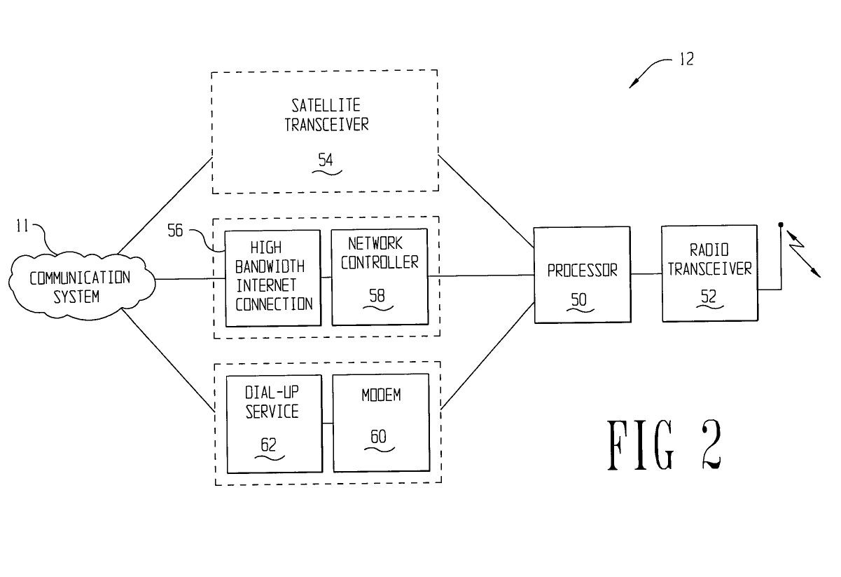

The store controller 12 may manage communication between the server 10 and the one or more advertising players 14 for which it is responsible. FIG. 2 illustrates a store controller 12 constructed in accordance with at least some embodiments of the invention. The store controller 12 may comprise a processor 50 which may be any suitable microprocessor or microcontroller, but in at least some embodiments the processor 50 may be a microcontroller produced by Microchip having a part number 18F452, or a Atmel Corporation part number ATmega128. The processor 50 may couple to a radio transceiver 52. The radio transceiver 52 may be responsible for communicating with the one or more advertising players 14 in the region of the store controller 12. In at least some embodiments of the invention, the radio transceiver 52 may operate at 900 MHz, such as devices produced by MaxStream, Inc. of Orem, Utah, and Xemics USA Inc. of Mountain View, Calif. FIG. 2 also illustrates three possible systems to couple the store transceiver 12 to the communication system 11, though others may be possible. Thus, in some embodiments of the invention the store controller 12 may couple to the communication system 11 by way of a satellite transceiver 54. Many retail stores, such as grocery stores and possibly smaller convenience stores, operate their own dedicated satellite network. In these circumstances, the primary server 10 may be located at a central facility and may communicate with one or more store controllers 12 over a satellite system. In this exemplary case, the communication system 11 may thus be a satellite-based communication system. In alternative embodiments of the invention, the communication system 11 may be the Internet, and thus the store controller 12 may couple to the communication system 11 by way of a high bandwidth Internet connection 56, such as a digital subscriber line connection or possibly by way of a cable modem. In these circumstances, the processor 50 may communicate with the cable modem or DSL controller by way of a network controller 58. Though high bandwidth (and therefore higher speed) Internet connections may be desirable, various embodiments of the invention may still be operable even if the store controller 12 couples to the communication system 11 being Internet by way of a modem 60 and dial-up service 62. In accordance with at least some embodiments of the invention, communications between the controller 12 and the server 10 may use a TCP/IP connection across the communication system 11. The controller 12 may communicate with one or more advertising players 14 over a radio transceiver 52. Because the communication between the store controller 12 and the one or more advertising players 14 may be slower than the speed at which the store controller 12 communicates to the primary server 10 over the communication system 11, the store controller 12 may perform buffering and spooling of the information to prevent data loss. For example, the wireless connection to each advertising player 14 may operate at 19,200 baud, whereas an exemplary DSL Internet connection may operate at 1 Mbit, and an exemplary dial-up connection may operate at 56,000 baud. The store controller 12 may periodically (e.g. approximately once each hour) test the wireless connection for the advertising player 14. Faulty advertising players 14 may be reported to the server 10.

Although controllers 12 may have unique addresses, most of the information from the servers 10 is bound for the advertising players 14. For example, an advertisement from server 10 to advertising players 14 may be received by the controller 12 via TCP/IP, and then relayed over a wireless connection. The wireless connections disclosed herein may be any one of various wireless standards, such as 900 MHz, 2.4 GHz, IEEE 802.1 lb, Bluetooth, and the like.

FIG. 3 illustrates an advertising player 14 constructed in accordance with at least some embodiments of the invention. An advertising player 14 may thus comprise a processor 18, which may be a microcontroller produced by Microchip having a part number 18F452, or a Atmel Corporation part number ATmega128. While a microcontroller generally may have on-board random access memory (RAM) and read-only memory (ROM), additional RAM 20 and ROM 22 may be coupled to the processor 18. In alternative embodiments of the invention, the processor 18 may be an individual microprocessor together with a chipset and external RAM 20 and ROM 22 to perform the computing functionality.

In order that the advertising player 14 may communicate with the store controller 12 and the primary server 10, a radio transceiver 24 may be coupled to the processor 18. The radio transceiver 24 may thus be responsible for forming at least part of the communication link between the advertisement player 14 and the primary server 10. The radio transceiver 24 may be a device manufactured by MaxStream having a part number X09-019NSI. In alternative embodiments, a communication system such as a network interface may be used in addition to or in place of the radio transceiver. Such a network interface may allow the advertising playing to communicate over a hard-wired connection to the store controller 12, or the advertising player 14 may bypass the store controller 12 and communicate directly to the primary computer.

An advertising player 14 may also comprise a sensing device 26 coupled to the processor 18. As will be discussed more fully below, the sensing device 26, in its many possible forms, may be responsible for detecting the presence of a consumer proximate to the advertising player 14 and/or a product display with which a particular advertising player 14 is associated. The advertising player 14 may further comprise a video display 24 coupled to the processor 18 by way of a video decoder 35. A video display may be the mechanism by which images (whether single images or moving video) may be displayed. The video display 24 may take many possible forms, such as a cathode ray tube, an active-matrix flat panel display, or a liquid crystal (LCD) display. In at least some embodiments of the invention, the video display 24 may be a LCD manufactured by L. G. Philips having a part number LB070W02.

The advertising player 14 may also comprise a communication device, such as a speaker 26, coupled to the processor 18 by way of an audio voice encoder (vocoder) 28. The audio vocoder 28 and speaker 26 may play audio advertisements alone, or as accompaniment to the pictures or video images on the video display 24. The audio vocoder 28 may be a device in a chip set available from RC Systems of Everett, Wash., having a part number RC8650. This chip set may also comprise media storage 21, possibly a flash memory, in which digital versions of the advertisements may be stored. The processor 18, in combination with the RAM 20, media storage 21 and/or ROM 22, may store advertisements, possibly provided from the primary server 10 through the store controller 12 for play-back. The audio driver 28 may likewise have the capacity to store audio or audio versions of advertisements. Though the video decoder 35 and audio vocoder 28 are shown coupled to the various memory devices (RAM, ROM and media storage) through the processor, each of the video decoder 35 and audio vocoder 28 may be capable of direct memory access, and thus in some embodiments may couple directly to the various memory devices.

For purposes of discussing various embodiments of the invention, consider an advertising system 100 such as that illustrated in FIG. 1. The primary server 10, and possibly work station 16, may be placed at a central location, such as a corporate headquarters for a grocery store chain. A plurality of store controllers 12 may be located at least one each in one or more of the grocery stores owned by the grocery store chain. Within each store, there may be a plurality of advertising players 14 in communication with their store controller 12, and therefore in communication with the primary server 10. Though the following discussion is directed to an exemplary system operating within a grocery store and grocery store chain, this description should not be construed as limiting the use of the methods and systems to just grocery stores. Any retail establishment may utilize the methods and systems discussed herein.

Further consider that one of the advertising players 14 is placed within a freezer having a door. When the advertising player 14 is initially powered up, the primary server 10 may be made aware (or detect) of the presence of the advertising player 14 and thus may transfer a plurality of advertisements, in electronic form, to the media slots of the advertising player 14. The transfer of advertisements in electronic form may comprise the primary server 10 communicating the various files to the store controller 12 over the communication system 11. The store controller 12 may, in turn, forward the files to the advertising player 14, possibly at communication rates different than the communications from the primary server 10. Thus, the store controller 12 may, in some embodiments, act as a buffer and translation device, controlling the speed at which communication may flow between the store controller 12 and the advertising player 14, and possibly also implementing protocols to facilitate the communication. Thus, the advertising player 14 may be provided with a plurality of advertisements to play.

In the exemplary case of the advertising player 14 being placed within a freezer, the sensing device (FIG. 2) may be an ultrasonic sensor monitoring the status of the door. In these exemplary embodiments, when a consumer opens the freezer door, the sensing device 36 may thus signal the processor that a consumer has been detected. In accordance with embodiments of the invention, upon detecting of a consumer, the advertising player 14 selects one of its plurality of advertising messages, and displays that message on one or both of the video display and audio driver. The advertisement may take many forms, such as attempting to influence the purchaser to a particular brand or type of product within the freezer case. Alternatively, the advertisement may provide information relating to the products in proximity to the advertising player 14, such as nutritional information.

After a first user has made a selection and walked away, a second user may approach and open the freezer door. Again, upon detecting the presence of a consumer (in this case by motion of the freezer door), the processor may again invoke playing of an advertising message. While it may be possible for the advertising player 14 to repeat a single message each time a user is detected, preferably the advertising player 14 selects a different advertisement than was played immediately previously. The selection may be a random selection, or some form of round-robin selection scheme. Thus, even if the same consumer opens the exemplary freezer door for a second and possibly a third time, in accordance with embodiments, different advertisements may be triggered.

In some embodiments, an advertising player 14 may communicate with other advertising players in close proximity. Such communication may be for the purpose of coordinating advertising play, or possibly ensuring that advertisements played on one advertising player do not interfere visually or audibly with other advertising players in close proximity.

The advertising player 14 of the various embodiments may also have the capability of tracking various parameters associated with playing a particular advertisement. For example, an advertising player 14 may keep track of a number of times a particular advertisement was played in a given period of time, such as a day. The primary server 10 may periodically poll the advertising player 14 for the statistics or metrics regarding the number of times the stored advertisements have been played. Alternatively, the advertising player 14 may report this information back to the primary server 10. Before proceeding, it should be understood that while the primary server 10 may many times throughout the day deliver advertisements to the advertising players 14, and the advertising players 14 may report statistics or metrics regarding advertising play back to the primary server, the advertising players 14 need not be in communication with the primary server to be operable. For example, if the communication system 11 is inoperable, the advertising players 14 may continue to play advertisements selected from their various media slots, and track their usage. Upon the communication system 11 becoming operable, the statistics may be transferred or different advertisements may be provided.

Though the embodiments above are described in reference to a freezer having a door, this need not necessarily be the case. The advertising player 14 may likewise be placed in operational relationship to a coffin-type freezer, where a consumer reaches through an open top to access the products within. The sensing device 26 may be an ultrasonic sensor, except in this case the sensing device may detect motion of the consumer (as opposed to motion of a door caused by a consumer). Alternatively, in these embodiments the sensing device 26 may be an optically-based device, such as a laser system, in which breaking of a light beam may be the trigger playing an advertisement.

The previous two embodiments were discussed with respect to some kind of refrigerated or freezer case; however, the various embodiments of the invention are not limited to use in connection with refrigerated items. In particular, an advertising player could be placed proximate to a magazine rack, a shelf containing goods such as canned goods, a display case, a gas pump, and a stand on which fruit items may be displayed for sale, to name a few. In these exemplary cases, the sensing device 26 may take any suitable form where the presence of the consumer proximate to the advertising player may be detected. Detecting a consumer in these exemplary situations may be done using an ultrasonic sensing device, an optical device, devices that detect local changes electric or electromagnetic field caused by a person's body (such as devices manufactured by Motorola having a part number MC33794), or the consumer may activate the advertisement directly, such as by pushing a button or standing on a floor mat that contains an electrical switch.

Other methods for detecting presence of a consumer may involve detecting the presence or proximity of a radio frequency identification device (RFID), such as RFID devices available from CopyTag LTD of the United Kingdom, having part number CTTC4 or CRRC1. In these cases, the sensing device 26 may be an RFID reader, such as devices available from CopyTag having a part number CTCR1. If a particular consumer does not already have an RFID device which uniquely identifies the consumer, the retail store within which the advertising player 14 may be located may provide RFID tags to consumers, such as by embedding those tags in preferred customer cards. Regardless of the mechanism by which a consumer is provided an RFID tag, the advertising player 14 may detect the presence of the consumer by reading the RFID tag, and then may provide consumer-specific advertising.

The embodiments discussed to this point have been directed to providing advertising in forms such as video clips and/or audio clips. However, in alternative embodiments advertising players 14 may provide advertisements directed to other senses of the consumer, such as a sense of smell. Referring again to FIG. 3, advertising player 14 may thus comprise a smell release device 30, possibly containing chemicals designed to be smelled by the consumer. Thus, as the advertising display device 14 detects the presence of a consumer, a small amount of chemical may be released as a way to interest the consumer in a consumer product related to that smell. As an example only, an advertising player 14 may release small amounts of cologne or perfume in an attempt to interest the consumer in the purchase of these type consumer products. As yet another alternative, an advertising player 14 may release a small amount of chemical that reminds the consumer of the possibility of purchase of a particular food item.

In yet other alternative embodiments of the invention, the advertising player 14 may comprise a RFID reader 32 coupled to the processor 18. The RFED reader 32 may be a device capable of reading RFID tags which may, for example, be placed within the packaging or on the consumer goods proximate to the advertising player 14. As these consumer goods are removed from the shelf or otherwise relocated, they may pass through the reading beam of the RFED reader 32. Thus, the advertising player 14 may detect which consumer devices that the consumer has removed from the shelf. This information may be reported back to the store controller 12 and/or the primary server 10. In some embodiments, detection of the removal of particular consumer goods may itself invoke playing related advertisements. Alternatively, the advertising player 14 may inform the consumer of the price of the product selected, or that the consumer may be given a discount at check-out. In the case where the sensing device 26 is also an RFID reader, the store may track and attribute the purchase by using the data collected by the advertising player 14.

The above discussion is meant to be illustrative of the principles and various embodiments of the present invention. Numerous variations and modifications will become apparent to those skilled in the art once the above disclosure is fully appreciated. For example, it may be possible for the advertising player 14 to communicate to the primary server 10 without the intervention of the store controller 12, such as connecting to an existing internal network. It is intended that the following claims be interpreted to embrace all such variations and modifications.

What is claimed is:

1. A method comprising:
sensing presence of a consumer proximate to a display of consumer goods;
invoking, based on the presence of the consumer, an advertisement selected from a group of previously supplied advertisements, the advertisements directed to at least one sense of the consumer; and
reporting statistics of invocation of advertisements.

2. The method as defined in claim 1 wherein sensing the presence of the consumer further comprises ultrasonically detecting the presence of the consumer.

3. The method as defined in claim 1 wherein sensing the presence of the consumer further comprises detecting changes in an electric field caused by presence of the consumer.

4. The method as defined in claim 1 wherein sensing the presence of the consumer further comprises optically detecting the presence of the consumer.

5. The method as defined in claim 4 wherein optically detecting further comprises detecting using a laser system.

6. The method as defined in claim 1 wherein sensing the presence of the consumer further comprises detecting a radio frequency identification device carried by the consumer.

7. The method as defined in claim 1 wherein invoking an advertisement directed to at least one sense of the consumer further comprises invoking an advertisement directed to at least one sense selected from the group: visual, audio and olfactory.

8. The method as defined in claim 1 wherein invoking an advertisement further comprises playing a video clip.

9. The method as defined in claim 8 wherein invoking an advertisement further comprises playing a video clip with audio.

10. The method as defined in claim 1 wherein invoking an advertisement further comprises playing an audio clip.

11. The method as defined in claim 1 wherein invoking an advertisement further comprises releasing a chemical to be detected by the consumer's sense of smell.

12. The method as defined in claim 1 further comprising detecting removal of a consumer good from the display of consumer goods.

13. The method as defined in claim 12 wherein detecting removal of a consumer good from the display of consumer goods further comprises reading a radio frequency tag embedded in the consumer good as the tag passes through a reading beam.

14. The method as defined in claim 1 wherein the display of consumer goods is a product display having a door, and wherein sensing presence of the consumer further comprises sensing opening of the door.

15. The method as defined in claim 14 wherein sensing opening of the door further comprises ultrasonically detecting opening of the door.

16. The method as defined in claim 14 wherein invoking an advertisement directed to at least one sense of the consumer further comprises invoking an advertisement directed to at least one sense selected from the group: visual, audio and olfactory.

17. The method as defined in claim 14 wherein the product display having a door is a freezer.

18. An advertising system comprising:
a first computer system;
a remote advertising player coupled to the first computer system by way of a communication system; and
wherein the remote advertising player senses presence of a person, and plays an advertisement stored in the remote advertising player previously supplied by the first computer system, and wherein the remote advertising system reports a metric of advertising play to the first computer system.

19. The system as defined in claim 18 wherein the communication system comprises, at least in part, a wireless communication system.

20. The system as defined in claim 19 wherein the remote advertising player further comprises:
a radio frequency communication circuit that may at least periodically wirelessly coupled to the first computer system;
a storage medium coupled to the radio frequency communication circuit, the storage medium storing advertisements; and
a communication device for reproducing the advertisement.

21. The system as defined in claim 20 wherein the communication device further comprises video display.

22. The system as defined in claim 20 wherein the communication device further comprises an audio speaker.

23. The system as defined in claim 22 wherein the communication device further comprises a video display.

24. The system as defined in claim 18 further comprising a second computer system coupling the first computer system and the remote advertising player, and wherein the second computer system facilitates communications between the first computer system and the advertising player.

25. The system as defined in claim 24 wherein the second computer system couples to the first computer system by way of an Internet connection.

26. The system as defined in claim 25 wherein the second computer system couples to the first computer system by way of a satellite communication system.

27. The system as defined in claim 24 wherein the second computer system couples to the advertising player by way of the wireless communication system.

28. The system as defined in claim 18 further comprising a sensing device coupled to the advertising player, and wherein the advertising player plays advertisements when the sensing device detects presence of a person.

29. The system as defined in claim 28 wherein the sensing device further comprises an ultrasonic sensor.

30. The system as defined in claim 29 wherein the ultrasonic sensor is in operational relationship to a door of a freezer.

31. The system as defined in claim 28 wherein the sensing device further comprises an electric field sensing device adapted to detect presence of the person by changes in ambient electric field caused by the person.

32. The system as defined in claim 28 wherein the sensing device further comprises an optical sensing device.

33. The system as defined in claim 32 wherein the optical sensing device further comprises a laser based sensing device.

34. The system as defined in claim 28 wherein the sensing device further comprises a radio frequency identification tag reader, and wherein the radio frequency identification tag reader detects a person carrying a radio frequency identification tag.

35. The system as defined in claim 18 further comprising a radio frequency identification tag reader coupled to the advertising player, and wherein the advertising player detects that a person has removed an item from a group of items by scanning a radio frequency identification tag associated with the item.

36. The system as defined in claim 18 further comprising a third computer system coupled to the first computer system, the third computer system used to create advertisements.

37. The system as defined in claim 18 wherein the advertising player provides information to a person about products proximate to the advertising player.

38. The system as defined in claim 37 wherein the advertising player provides nutritional information about foods proximate to the advertising player.

39. A system comprising:
a processor;
a random access memory (RAM) coupled to the processor;
a communication device coupled to the processor;
a sensing device coupled to the processor; and
an advertisement reproduction device coupled to the processor;
wherein the system receives advertisements by way of the radio frequency communication device and stores the advertisements in the RAM;
wherein the processor is programmed to sense proximity of a consumer using the sensing device, and when a consumer is detected by the sensing device, the processor is further adapted to play an advertisement stored in the RAM on the advertisement reproduction device;
wherein the processor is further programmed to send data to external devices, by way of the radio frequency communication device, regarding statistics of advertising play.

40. The system as defined in claim 39 wherein the sensing device comprises at least one device selected from the group of: ultrasonic sensor, laser device, magnetic flux change sensor, and radio frequency identification tag reader.

41. The system as defined in claim 39 wherein the advertisement reproduction device further comprises an audio speaker.

42. The system as defined in claim 39 wherein the advertisement reproduction device further comprises a video display.

43. The system as defined in claim 42 wherein the advertisement reproduction device further comprises a audio speaker.

44. The system as defined in claim 42 wherein the video display further comprises a touch screen control panel, and wherein the system is adapted to interactively provide information to the consumer.

45. The system as defined in claim 39 wherein the communication device further comprises a radio frequency communication device.

46. The system as defined in claim 39 wherein the communication device further comprises a network interface.

47. A system comprising:
a means for executing programs and storing information;
a means for reproducing advertisements coupled to the means for executing programs by way of means for wirelessly communicating; and
wherein the means for reproducing senses presence of a person, and plays advertisements stored in the means for reproducing previously supplied by the means for executing.
